(19) United States
(12) Patent Application Publication
(10) Pub. No.: US 2008/0306796 A1
(43) Pub. Date: Dec. 11, 2008

(54) METHOD AND SYSTEM FOR PROVIDING CLOSED-LOOP OPERATIONS CONSULTING AND OPTIMIZATION

(75) Inventors: JONATHAN ZIMMERMAN, San Diego, CA (US); CYNTHIA C. YAMAGA, San Diego, CA (US)

Correspondence Address: OBI ILOPUTAIFE, Cardinal Health 303, Inc, 10221 Wateridge Circle, San Diego, CA, 92121, US

(73) Assignee: CARDINAL HEALTH 303, INC., San Diego, CA (US)

(21) Appl. No.: 11/759,576

(22) Filed: Jun. 7, 2007

(51) Int. Cl. G06F 9/46

(52) U.S. Cl. 705/8

(57) ABSTRACT

A closed-loop system and method for optimizing one or more aspects of the operation of a facility or business is presented. The system includes a platform at a remote provider for accepting and storing data from the facility for analysis. The system facilitates a live consultation such that information is exchanged between the parties, including facility data in analyzed or unanalyzed form for reference during the consultation, recommendations are made in relation to the facility data relative to one or more aspects of the operation of the facility, video and audio of the representative conducting the live consultation, and a whiteboard configured to display input by one or more parties. The method allows skilled experts to provide recommendations of actions for optimizing one or more aspects of operations at a facility, without the requirement that the facility maintain an infrastructure of trained personnel and equipment.

### FIELD OF THE INVENTION

The present invention relates to methods for improving or optimizing operations of a business or other entity.

### BACKGROUND OF THE INVENTION

A variety of methods are known for improving or optimizing operations. Such methods may be directed to improving in manufacturing operations to reduce product defects to streamlining business operations to reduce overhead costs. For example, SIX SIGMA® (a registered trademark of Motorola Corporation) is a system of practices developed to improve processes by eliminating defects. Total Quality Management or “TQM” is a management strategy that aims for increases in customer satisfaction at lower operational costs. LEAN manufacturing is set of tools that assist in the identification and steady elimination of waste, while improving quality and reducing production time and cost.

While implementation of these various methodologies has been shown to result in operational benefits, all of the methodologies require measurement, analysis, change, and most importantly, significant human resources. In particular, institutions which desire to implement these methodologies must generally train and employ large numbers of personnel for implementing the methodologies. The cost of training these personnel and maintaining them on-site is very high. In addition, various of the methodologies may require the institution to make significant investments in software and hardware for tracking and analyzing information to be used in the optimization method.

A more efficient and effective method of improving or optimizing operations is desired.

### SUMMARY OF THE INVENTION

One aspect of the invention is a method and system for providing closed-loop consulting.

In one embodiment of the invention, a facility or business provides data regarding its operations to a remote or outside provider. This provider preferably comprises a business or other entity which has particular resources for use in analyzing the data and providing recommendations regarding the facility's operations. These resources may include personnel or “experts” having unique knowledge, skill or education in one or more particular subjects for use in reviewing and analyzing the data and providing recommendations, as well as other resources such as computers, databases of information, and algorithms or software for analyzing information. The recommendations may relate to actions for optimizing facility operations, such as maximizing revenues, minimizing costs, maximizing customer satisfaction, maximizing customer service, minimizing defects or errors, and maximizing efficiency. The remote provider provides the recommendations to the facility via a live consultation. The facility may then implement the recommendations in order to optimize one or more aspects of its operation.

In accordance with a method of the invention, information or data regarding one or more operations of a facility are collected and then transmitted to a remote provider. The remote provider analyzes the facility data to generate one or more recommendations regarding aspects of the operation of the facility. A live consultation is conducted between the remote provider, such as a representative thereof, and the facility, such as personnel thereof.

In a method of conducting the live consultation, a communication link is established between the parties. Facility data in analyzed or unanalyzed form is transmitted from the remote provider to the facility for reference during the consultation. Recommendations are also transmitted by the remote provider to the facility for discussion. In a preferred embodiment, video and audio of the remote provider representative are transmitted to the facility. Lastly, a whiteboard is transmitted to display input by one or more of the parties during the consultation.

In one embodiment, the method of conducting the live consultation comprises generating a graphical user interface having four display area, a first of which displays the transmitted facility data, a second of which displays the transmitted recommendations, a third of which displays the video, and a fourth of which displays the whiteboard.

In accordance with a system of the invention, facility data is collected and transmitted from a computer of the facility via a communication link to a platform of the remote provider. The facility data may be stored at the remote provider's platform for analysis.

The system preferably also comprises at least one workstation at the facility and one remote provider workstation. The remote provider workstation includes video and audio capture devices configured to capture an image of a representative of the remote provider and associated audio. The workstation may also include other input devices. The workstation at the facility is configured to present the transmitted information, and may include a video display and speakers for presenting the video and audio information. The facility workstation may also include video and audio capture devices.

In accordance with the invention, the live consultation permits facility personnel and a remote provider representative to discuss or consult various recommendations with associated relevant data at hand, while viewing one another, and with the opportunity to collaborate and provide various input via the whiteboard in real time.

The method and system of the invention may be utilized in conjunction with various facilities or businesses, such as a medical facility, manufacturing facility, or financial or investment institution.

Further objects, features, and advantages of the present invention over the prior art will become apparent from the detailed description of the drawings which follows, when considered with the attached figures.

### BRIEF DESCRIPTION OF THE DRAWINGS

FIG. 1 is a schematic view of a system for closed-loop operations consulting and optimization in accordance with an embodiment of the invention;

FIG. 2 is a block diagram of various elements of a system of the invention;

FIG. 3A is a flow diagram of a method of the invention;

FIG. 3B is a flow diagram of a method of live consultation in accordance with a method of the invention; and

FIG. 4 is a schematic view of an example method of use of a system of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a method and system for operations or operational consulting. In one embodiment, the system is a closed-loop system which may be used to optimize one or more aspects of the operation of a facility or business.

As used herein, the terms “facility”, “business” or “institution” may refer to any type of entity, whether a sole proprietorship, corporation or the like. Further, such terms are not limited to entities which provide particular goods or services. For example, the facility may be a doctor's office or a hospital. The facility might be a manufacturing facility. The business might be a financial institute such as a bank or brokerage. In general, the method and system of the invention have wide-ranging applicability, including to that which may later be developed or determined.

As used herein, the terms “operations” or “operational” may refer to any function or aspect of any facility, business, institution or other entity. For example, the term “operations” may refer to the activities of a hospital in providing medical services. The term “operations” might also refer to the manufacture of a product, management of a business or a wide range of other activities or functions.

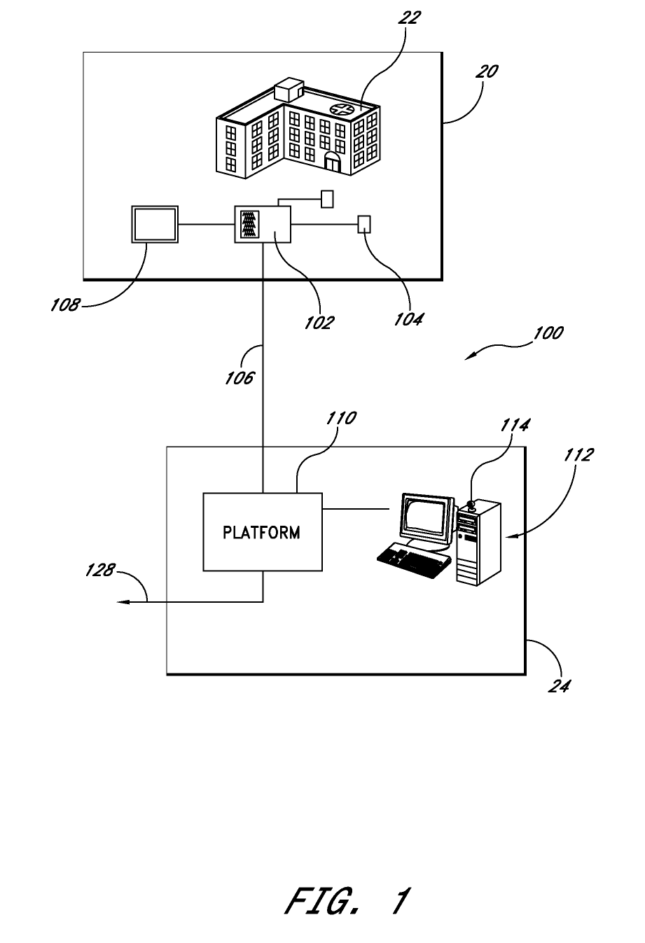

FIG. 1 schematically illustrates one environment of use of a method and system of the invention, as well as aspects of the system. In accordance with the invention, the method and system may be utilized relative to a facility 20. In one embodiment, the facility 20 may comprise a hospital. In such an embodiment, the facility 20 may comprise at least one physical structure 22, various elements of personal property and various personnel for providing medical services. As indicated above, the facility need not be a hospital.

In addition, the invention comprises a remote provider 24. The remote provider 24 may be “remote” either or both the physical and temporal sense. In one embodiment, the remote provider 24 is at one or more physical locations which are separated in space from the facility. In another embodiment, the remote provider 24 is separate in control, management or other temporal sense, regardless of the remote provider's physical location, if such exists. The remote provider 24 preferably provides information analysis, operation optimization and consultation services. As detailed below, the remote provider 24 may comprise a business which has unique resources for use in providing such services. These resources may include a number of representatives which have unique knowledge, skill or education in one or more particular subjects. Due to the representatives having a high level of skill or knowledge compared to general employees of a facility, these representatives may be referred to as “experts” or “subject matter experts” when considering particular subjects or issues. As detailed below, the remote provider 24 may have other resources for use in providing the services detailed herein, such as computers, databases of information, and algorithms or software for analyzing information.

As will be described in greater detail below relative to a method of the invention, in a preferred embodiment, the facility provides operational data or information to the remote provider. The remote provider analyzes the data or information and develops recommendations for improving operations of the facility. These recommendations are preferably presented in a live consultation.

Still referring to FIG. 1, in one embodiment of the invention, a system 100 comprises at least one computing device 102 associated with the facility 20. In a preferred embodiment, the computing device 102 is configured to receive information from one or more sources associated with the facility, and to transmit information to and receive information from, at least one point external to the facility. The computing device 102 may be configured to perform a variety of other functions, such as store information and manipulate or process information.

The computing device 102 may comprise a variety of hardware and/or software for performing these one or more functions. For example, the computing device 102 might comprise a server configured with at least one communication port, one or more data storage devices such as one or more hard drives, disk drives, ROM, RAM, EPROMs or other devices now known or later developed, and one or more processors.

As indicated, the computing device 102 is preferably configured to receive information about the facility or from one or more sources associated with the facility. In one embodiment, the system 102 includes one or more data collection devices 104.

The data collection devices 104 may be automated and/or manual. For example, the data collection devices 104 could merely comprise one or more user input devices such as touch-screens, keyboards, keypads or the like, via which a user may manually input information.

In other embodiments, the data collection devices 104 could be partly or entirely automated. The data collection devices 104 may comprise individual sensors or entire data collection systems which are associated with the computing device 104. For example, relative to a hospital, one or more data collection devices 104 might comprise infusion pumps configured to report information regarding administered medication (such as types and quantities of medication), a drug formulary which tracks inventories of drugs/medication, an inventory system which tracks quantities of other medical supplies, and even personnel time systems which track personnel and work times.

As indicated, the computing device 102 is configured to transmit information to a remote location and receive information from a remote location. As indicated, the computing device 102 may be configured to establish at least one communication link 106 with at least one remote location, such as the remote provider 24. In this regard, the computing device 102 is preferably configured with at least one communication port. For example, if the communication link 106 is a wireless link, the communication protocol and associated communication port architecture may be Bluetooth or IEEE 802.11x. For wired links, the protocol/architecture may be USB, RS-485, IEEE-1394 (Firewire®), Ethernet or TCP/IP.

In one embodiment, the communication link 106 may comprise a plurality of links. For example, the computing device 102 might be associated with a LAN of the facility and communicate with a communication port of a communication device associated with the LAN. In turn, that communication device may be linked to the communication link 106. As detailed below, in one embodiment of the invention, the communication link 106 is utilized to transfer information or data from the computing device 102 to one or more other devices. Those devices may be remote from the computing device 102. In such embodiments, the communication link 106 might comprise a dedicated link, or might comprise a link through the Internet or other third party networks. In addition, the communication link 106 might comprise more than one link or might comprise different links at different times.

It is noted that the computing device 102 need not be physically located at the facility. For example, the computing device 102 might be located at a secure location remote from the facility.

In a preferred embodiment, the system 100 includes at least one device configured to present information at the facility 20. The information presentation device 108 preferably comprises at least one video display and, in one or more embodiments, at least one audio presentation device. For example, the video display might comprise a CRT, plasma, LCD, DLP or other type of image display device. The audio presentation device may comprise at least one speaker.

Preferably, the information presentation device 108 is configured to receive information from a remote location and present information. In one embodiment, the information presentation device 108 is linked to the computing device 102. In another embodiment, the information display device 108 may include its own communication port for receiving information from an external location via one or more communication links which may be separate from the communication link 106 to the computing device 102.

Preferably, the information display device 108 includes requisite data processing equipment for processing data for presentation. For example, the information display device 108 may include a video processor for processing video data. In another embodiment, such processing device(s) may be associated with the computing device 102 or another device. For example, the information display device 108 may comprise a peripheral of the computing device 102, in which case the computing device 102 may include the requisite video, audio and/or other processors.

In a preferred configuration, the information display device 108 is configured as a workstation and also includes one or more user input devices. These devices might comprise a keyboard, touch screen, keypad, light pen or the like, and audio and image or video capture or input devices such as a camera and microphone.

As further illustrated in FIG. 1, the system 100 further includes a business operations analyzing platform 110. This platform 110 is preferably associated with the remote provider 24.

In one embodiment, this platform 110 also comprises at least one computing device. Preferably, the platform 110 is configured to receive, analyze, and transmit information. In order to transmit and receive information, the platform 110 preferably includes at least one communication port for linking to the communication link 106 with the facility 20. Again, the configuration of the communication port may vary, depending upon the nature of the communication link or links.

The platform 110 preferably also comprises one or more data or information storage devices. The platform 110 is further configured to analyze data. In this regard, the platform 110 may include software or hardware, such as one or more processors for executing machine readable code, for analyzing data or information. As detailed above, the configuration of the platform 110 may vary depending upon the type of information to be analyzed.

In one embodiment, system 100 includes at least one workstation 112 associated with the remote provider 24. The workstation 112 preferably comprises means for receiving and transmitting information. In one embodiment, the workstation 112 may comprise a computing device which is associated with the platform 110. The workstation 112, however, could be a separate device.

In one embodiment, the workstation 112 includes an image or video capture device. This device may comprise at least one camera 114. The workstation 112 may include at least one audio capture or input device, such as a microphone, and at least one video display and at least one audio presentation device.

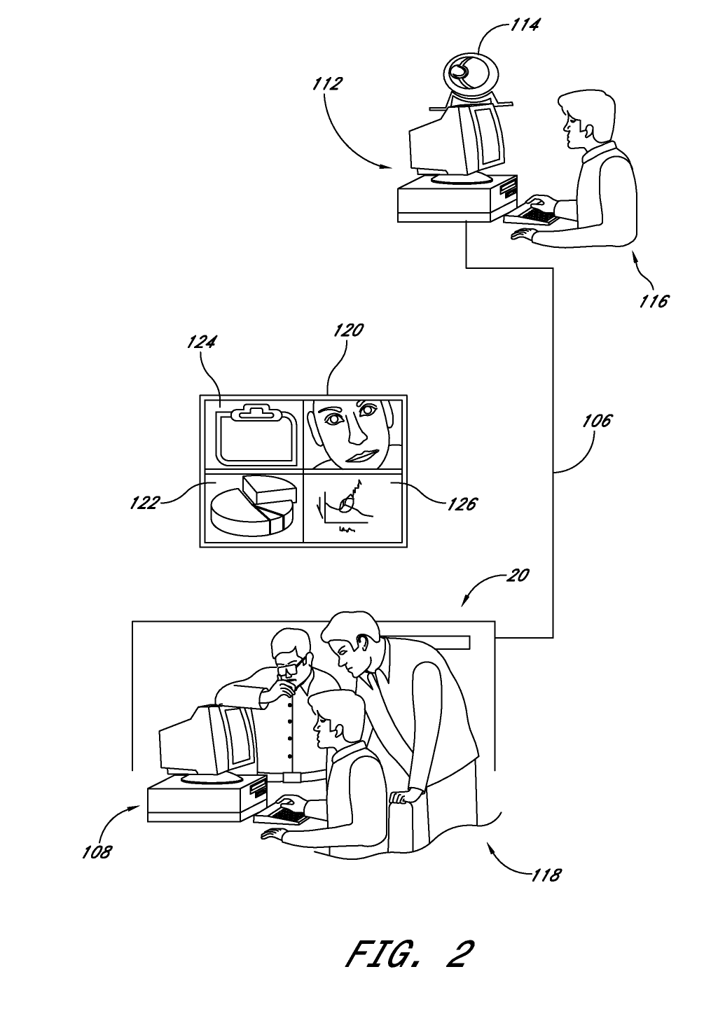

Referring to FIG. 2, in one embodiment, the system is configured to transmit and analyze various information. As detailed below, in one embodiment, the system 100 is configured to facilitate a live consultation between the facility 20 and the remote provider 24. In one embodiment, the live consultation includes exchange of information including images or video.

As illustrated, the system 100 permits a communication link 106 to be established between the facility 20 and the remote provider 24. Via this communication link 106, information may be transmitted between the remote provider 24 and the facility 22. In one embodiment, this permits a representative 116 of the remote provider 24 to interface with one or more personnel 118 at the facility 20 in a live consultation.

As indicated above, the communication link may comprise one or more links and may have a variety of configurations. In one embodiment, the communication link may be established via the Internet, such as by facility personnel 118 accessing a website of the remote provider 24, such as serviced by the platform 110.

In a preferred embodiment, video image information of the representative 116 is captured, such as via the camera 114, and is transmitted to the personnel 118 at the facility. In addition, other information is provided to the personnel 118. This information may be displayed via the information presentation device 108 at the facility 20.

As illustrated, in one embodiment, the information which is provided to the information presentation device 108 to the personnel 118 includes image information 120 of the remote provider representative 116, data 122, recommendations and/or analyzed information 124, and a whiteboard 126. This information may be provided in a variety of formats. As illustrated, the information may be presented via a graphical user interface in which the various information is displayed in various quadrants or portions of a screen. The various information could be displayed at different times, such as by being accessible via one or more tabs of a graphical user interface.

In one embodiment of the invention, the system 100 may also be configured to display similar information to the representative 116 of the remote provider. In this manner, the representative 116 and the personnel 118 at the facility 20 may view the same information at the same time. Of course, the image information which is displayed to the representative 116 may instead be image information regarding the personnel 118 (such as captured at the facility).

Of course, in the event the information is associated with a graphical user interface, the platform 110 or another computing device may be configured to generate that interface. It will also be appreciated that software or other information may be exchanged between or utilized by both the facility 20 and the remote provider 24 for implementing the graphical user interface, facilitating establishment of the communication link, and the like.

Additional aspects of the system will become apparent from the description below.

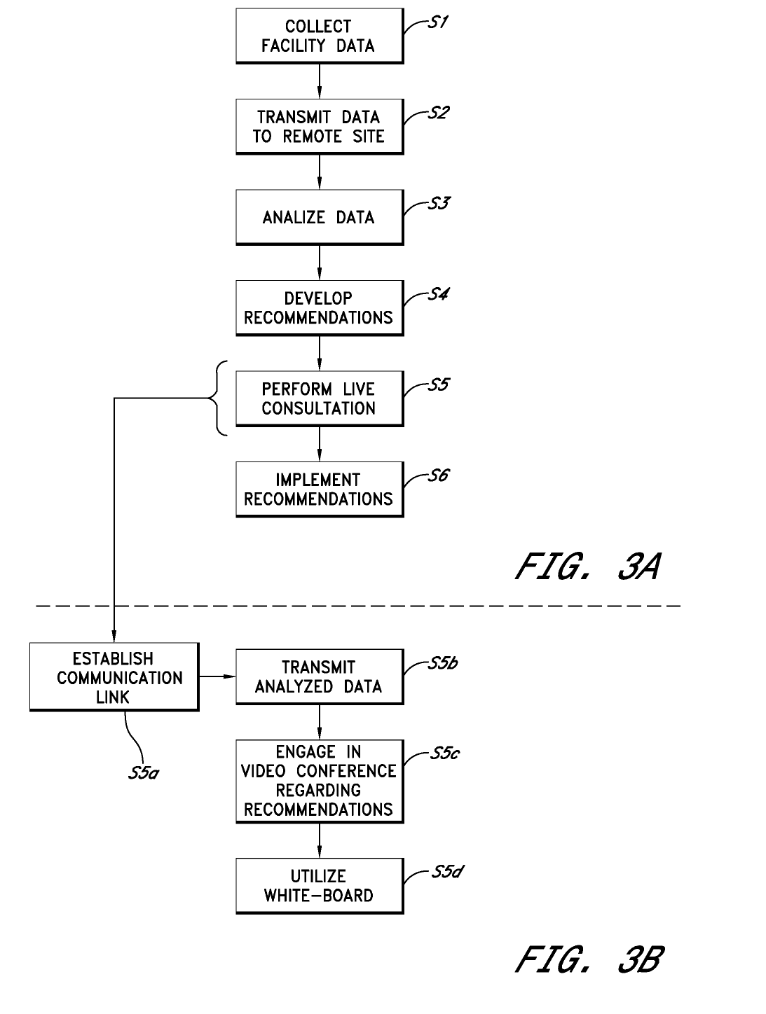

FIG. 3A illustrates one embodiment of a method of the invention. It will be appreciated that the method may be implemented in a variety of manners, including by variety of apparatus and systems. For ease of understanding, the description of this embodiment method will be provided with reference to the system described above.

In a first step S1, data regarding an operation or facility is collected. This may be accomplished in a variety of manners. As indicated above, information may be manually collected. In other embodiments, information may be collected automatically, such via sensors or systems.

The data which is collected may also vary. The collected data may relate to a specific activity or function, or may be wide ranging. For example, the data might relate specifically to particular drugs utilized by a hospital, or might more generally relate to a wide range of medical supplies utilized by a hospital.

In one embodiment, the collected data is provided to the computing device 102 of the facility 20. As indicated above, the data might be provided by various data collection devices 104, or by manual input or the like.

In a step S2, data is transmitted to the remote provider 24. The data which is transmitted may comprise all, or merely some, of the collected data.

Relative to the system 100 illustrated in FIG. 2, the data may be transmitted via the communication link 106 from the computing device 102 associated with the facility 20 to the platform 110 of the remote provider 24. In one embodiment, the transmitted data may be stored a memory or other data storage device associated with the platform 110. Of course, the information might be transmitted or provided in other manners.

In a step S3, the transmitted or provided data is analyzed by the remote provider 24. The data may be analyzed in various fashions. The data may be analyzed automatically and/or manually. For example, the data may be analyzed at least in part using one more methods or algorithms implemented via the platform 110, such as software executed thereby. For example, various software may be configured to analyze the data by applying filters and the like.

In another embodiment, the data may be analyzed directly by one or more representatives of the remote provider 24. These representatives may be experts, i.e. persons specifically trained for one or more tasks or having particular knowledge or skill.

Referring to FIG. 1, in one embodiment, various information may be obtained from a third party source for use in analyzing the data. For example, the platform 110 may link 128 to various external devices via one or more communication links. For example, the platform 110 might link to a manufacturer's supplier computer to obtain information regarding the price and availability of particular products or suitable substitutes. As indicated below, such information may be utilized in the optimization process.

In a step S4, information is generated from the step of analyzing the data. Preferably, this information comprises one or more observations or recommendations regarding activities or functions of the facility, and preferably actions for improving the operations of the facility. These recommended actions may be directed to achieving one more effects or goals including, but not limited to: lowering or minimizing costs or expenses, increasing or maximizing revenue, increasing or maximizing customer satisfaction, improving or maximizing customer service, lowering or minimizing error or defect rates, and raising or maximizing efficiency.

Preferably, at one or more times, the method includes the step of providing or performing a live consultation, as in step S5. In one embodiment, this consultation occurs via a communication link between the facility 20 and the remote provider 24 (i.e. it is live or real time, but various of the parties are physically remote from one another).

Referring to FIG. 3B, in one embodiment, the step of performing the live consultation comprises the step S5a of establishing a communication link between the remote provider 24 and the facility 20. Relative to FIGS. 1 and 2, this communication link may comprise the communication link 106 between the platform 110 and the computing device 102. However, the communication link could be a different link, such as a dedicated link. Regardless, the communication link preferably provides a link over which data or information may be transmitted between the remote provider 24, including the representative 116, and the facility 20, including the personnel 118.

In a step S5b, data is preferably transmitted from the remote provider 24 to the facility 20. In one embodiment, the transmitted data or information may include facility data used in developing the one or more recommendations, the facility data as analyzed, and/or that data and additional data. As illustrated in FIG. 2, this data 122 may be displayed to the personnel 118 at the facility 20. For example, the data which is transmitted to the facility 20 may comprise facility data which has been filtered or otherwise manipulated, such as placed into graphical or other form, for ease of reference by the personnel 118 and the representative 116.

In one embodiment, the information or data which is transmitted to the remote provider 24 to the facility 20 preferably also comprises recommendation information. For example, referring to FIG. 2, this information 124 may be displayed to the personnel 118 at the facility 20. In one embodiment, this information may comprise an identification of recommended actions to be undertaken by or at the facility 20, such as for improving operations of the facility.

In a step S5c, the step of performing the live consultation further comprises the step of transmitting video information. Preferably, the video information comprises at least live or real time (or close thereto, subject to processing, transmission and similar delays) video or images of at least one representative of the remote provider 24. Referring to FIG. 2, for example, the camera 114 may be utilized to capture video and audio information regarding the representative 116, which information is transmitted to the facility 20 for display 120 (and audio dissemination) to the facility personnel 118.

In addition, in a step S5d, the step of performing the live consultation preferably further comprises transmitting “whiteboard” information. As illustrated in FIG. 2, in one embodiment, a graphical user interface is generated and displayed at least the facility personnel 118, and preferably additionally to the representative 116. In one embodiment, the graphical user interface may include an area for displaying text, graphics or other information as provided or input by the personnel 118 and/or representative 116 during the live consultation. For example, the personnel 118 and representative 116 may collectively generate a list of action items, draw graphs or other illustrations or the like. This information may facilitate the consultation.

Referring again to FIG. 3A, after the live consultation, the facility 20 may implement one or more of the recommendations.

In one or more embodiments of the method, the method may involve the various steps in other orders, additional steps, or multiples of one or more of these steps. For example, in accordance with the method, the parties may conduct more than one live consultation.

As detailed below, in one embodiment a representative of the remote provider may be provided on-site at the facility 20 at one or more times. For example, such a representative might work with the personnel 118 of the facility 20 to implement the recommendations.

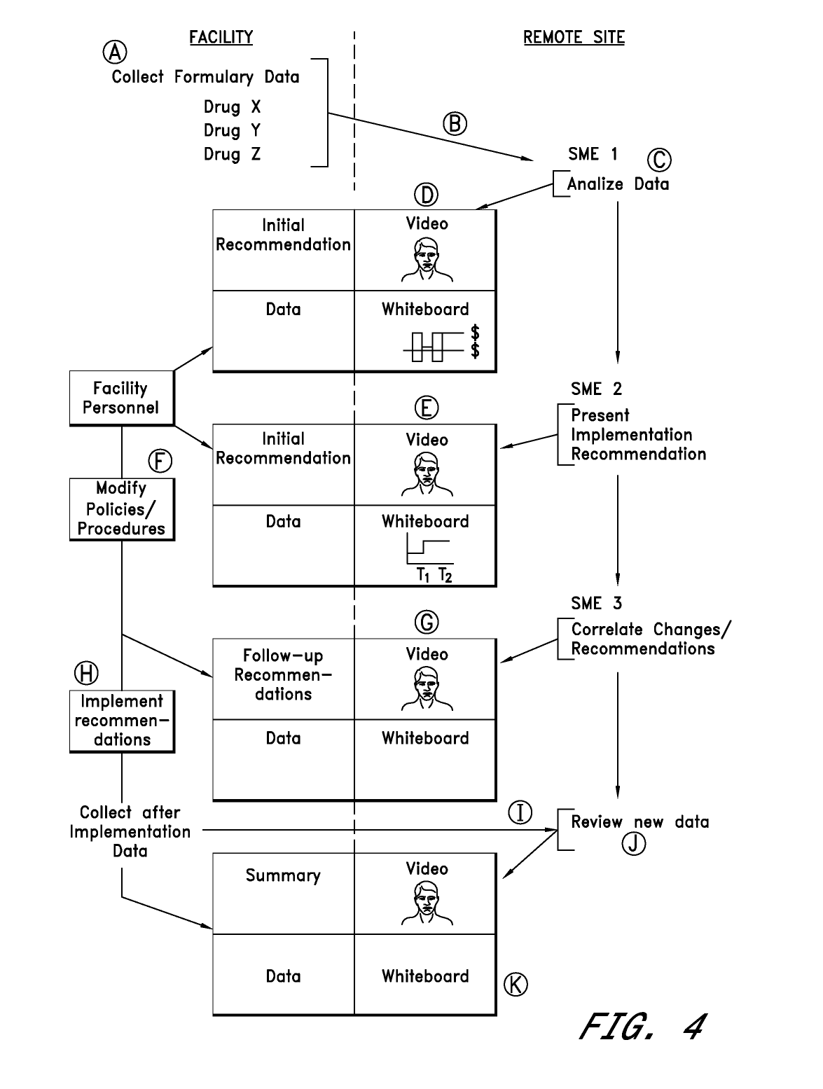

One example implementation of the system and method of the invention will now be described with reference to FIG. 4. In this example, the facility comprises a medical facility such as a hospital. The hospital utilizes various medications or formularies in the course of providing medical services. For example, the hospital may purchase a number of drugs for treating pain. These drugs, Drug X, Drug Y and Drug Z may be obtained from one or more sources and have differing costs. Preferably, information regarding the hospitals' purchases and use of these drugs is collected, as at “A” in FIG. 4. The drug purchasing and use information may be obtained by manual input, or by automated input. For example, purchasing information may be entered into a hospital computer system. In another embodiment, orders may be placed and incoming medication may be scanned into the hospital computer, thus providing drug inventory information to the hospital. This drug purchase information may include a variety of information, including the cost of each drug, the volume of use of the drug, the source of the drug, and/or other information.

In one embodiment, information regarding the hospitals' purchases and use of these drugs is transmitted to the remote provider, as at “B”. The drug information may be transmitted via a communication link from the hospital's computer to a remote provider. In one embodiment, the drug information is transmitted to a computer of the remote provider, where the drug information is stored for later analysis and use.

The drug information may be reviewed by a representative of the remote provider, as at “C”. In one embodiment, the representative is a subject-matter expert (SME) who has particular knowledge regarding the drug(s). For example, the SME may be a pharmacist or doctor who is particularly knowledgeable about the drugs and can determine that Drug X, Drug Y and Drug Z are acceptable substitutes for one another. The SME may determine that by standardizing to one of the drugs which is a lower cost than the others, the hospital would derive substantial cost savings over time.

Part of the SME's analysis may be performed with the aid of external data or programs. For example, the SME may interface with the platform of the remote provider. The platform may, in turn, interface with one or more external computers. For example, the platform may link (such as via the Internet) to a drug manufacturer's computer to obtain updated drug price information, drug use or other information.

In a preferred configuration, the SME and facility personnel conduct a live consultation as a step “D”. In the preferred embodiment, at least one communication link is established between the SME and the facility personnel, such as illustrated in FIG. 2. Preferably, the SME is visible to the facility personnel during the live consultation. The SME may also display some or all of the hospital's drug information or data, and display an initial recommendation. This recommendation might comprise different scenarios of drug purchasing demonstrating the cost savings realized if those scenarios were implemented. One or more of the scenarios might suggest, for example, the hospital only utilize one of the drugs, such as the lowest priced drug.

Because the facility personnel and SME can “see” each other during the consultation, they may obtain visual clues or information about the other. For example, one of the facility personnel might be the chief financial officer (CFO) for the hospital. The SME might see that the CFO appears puzzled about one or more of the scenarios. The SME might utilize the whiteboard to provide additional information about the scenarios, such as by drawing one or more charts.

As a result of the initial consultation regarding the drug issue, the facility personnel may agree that the institution of one of the scenarios might be beneficial in reducing hospital costs or expenses. The personnel might decide that it would be beneficial to consult with other hospital personnel before selecting one of the scenarios.

At a later live consultation, as at “E”, the hospital personnel may obtain more information about one or more of the scenarios/recommendations. For example, the hospital personnel might discuss the scenarios with a second SME of the remote provider. This second SME might have other expertise, such as being knowledgeable in formulary management. This second SME might provide various information, such as information regarding savings realized by other hospitals and recommendations regarding how to implement a selected cost saving scenario. The facility personnel and SME may discuss the particular recommendations in detail, again with the benefit of “seeing” one another during the consultation. Various information may also be exchanged via the whiteboard. For example, the agreed-upon selected scenario and course of implementation may be outlined, as well as metrics, timelines and other information. For example, implementation of the selected scenario may require the hospital to change its policies with regard to prescribing, dispensing and stocking the various drugs. In order to aid in the implementation of the recommended scenario, the SME may transmit additional information, such as a package of templates which may be utilized by the hospital.

The hospital may then work to modify its internal policies and procedures in preparation for transition to the new scenario, as at “F”. The parties may then conduct another live consultation, as at “G”. During this consultation, yet another SME, one skilled in distribution systems, may have reviewed the hospital's past use of the drugs. The SME may provide information regarding these usage patterns and may provide recommendations regarding how the hospital may move and use various of the drugs, such as to ensure the fastest depletion of the drugs which are being phased out (so as to increase inventory space, ensure that those drugs are utilized before their expiration date, and the like). The SME may also provide additional recommendations to ensure that the drugs which are being phased out are not re-ordered. These recommendations may be displayed directly to the facility personnel during the live consultation, and the parties may additionally exchange information utilizing the whiteboard.

The hospital may then implement the additional recommendations, as at “H”. After implementation of the new scenario, the hospital may collect additional data and transmit it to the remote provider, as at “I”. This information might comprise, for example, information regarding the depletion of those drugs which were being phased out, as well as information regarding purchases of the drug which was selected to be retained.

This information may be analyzed by the remote provider, as at “J”. An SME of the remote provider may review the data to, for example, generate cost savings summary information for the hospital.

The parties may then conduct a follow-up consultation, as at “K”. During this consultation, the remote provider may show the cost savings data to the hospital personnel to verify that the selected scenario derived the intended benefits.

Of course, this is but one specific example of use of the method and system of the invention. The method and system of the invention may be utilized in a variety of other manners and for other purposes. The method and system might be utilized to address other issues regarding the operations of a medical facility. As indicated above, however, the method and system may be utilized for a wide variety of other purposes and in other environments.

From this example it will be clear that the description of the method of the invention herein is not limiting. From the above-example, it will be apparent that the method may include multiple live consultations and involvement of a number of facility personnel and remote provider representatives. Various information may be analyzed, various information may be provided by the remote provider to the facility personnel, including various recommendations.

As indicated above, the system for implementing the method may vary. Various known technology and that developed hereafter might be utilized. For example, information might be transmitted between hand-held wireless devices. In one embodiment, information exchanged between the parties may be secured, such as via encryption in order to protect the information from interception.

As indicated, in one embodiment, information is exchanged between the parties during a live consultation. The information may be presented via a graphical user interface. In one embodiment, the interface defines four areas. These areas may comprise quadrants of a display area. The interface, however, might have other configurations. For example, the information might be displayed in different windows or by tabbed items. The video might be displayed as a ‘picture’ or window over other windows, as in a ‘picture-in-picture’ format. The users of the interface may be permitted to change the display format, such as by changing the sizes of display areas or the like.

In one embodiment, the remote provider may provide a representative at the facility. This representative may aid in reviewing, explaining and discussing information which is provided by the remote provider to the facility. This representative may also aid in implementing recommendations and in packaging and transmitting relevant information from the facility to the remote provider.

The method and system of the invention have numerous advantages. A particular advantage of the invention is that a facility may obtain the benefit of skilled personnel in analyzing, consulting and optimizing one or more aspects of the operation of the facility, without having to educate and employ those personnel or otherwise expending the significant resources which would otherwise be required. In accordance with the invention, a remote provider may provide consulting, analyzing and optimizing services for various facilities. In this arrangement, the remote provider can afford to employ numerous highly skilled or educate personnel or “experts” which are then accessible by various businesses, and at lower cost. For example, in the prior art paradigm, each facility would have to have its own “optimization” employees. Facility A and Facility B would each train and employ, as against the revenues of that facility, its own personnel. However, in accordance with the current scheme, a remote provider may employ a single employee who is capable of servicing both Facility A and Facility B, thus reducing the cost of the service as provided to each facility. Because of this arrangement, the remote provider may be able to make a greater range of subject-matter experts and other resources available to a facility.

Another particular advantage of the invention is the use of a live consultation in order to present recommendations and otherwise communicate between the remote provider and the facility. It has been determined that the use of a live communication link which allows the parties to see each other when information is exchanged greatly enhances the probability of success of the communications. In the past, merely transmitting information in data or aural form resulted in mis-communications or the like. In accordance with the present invention, because the parties can see one another, they can obtain information simply by seeing the expressions of the other, and by viewing other visual information.

As indicated, a further extension of this principle is the use of a “whiteboard” which allows the parties to generate and display to the other party specific visual information. This information may comprise text such as written lists and points, as well as graphical information such as charts. The whiteboard allows the parties to extend their communications beyond simple transmission of pre-prepared data.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A system for providing closed-loop operations consulting comprising:
a remote provider platform, said platform comprising:
a memory for storing facility data received from a facility regarding one or more operations of said facility;
a processor configured to analyze said facility data; and
at least one representative work station coupled to said platform, said work station including at least one video capture device and audio capture device;
whereby when a communication link is established between said platform and a remote facility, a representative of said remote provider may conduct a live consultation with said facility, said live consultation comprising:
transmitting facility data in analyzed or unanalyzed form for reference during the consultation;
transmitting one or more recommendations made in relation to the facility data relative to one or more aspects of the operation of the facility;
transmitting video and audio of a representative conducting the live consultation as captured at the at least one work station; and
transmitting a whiteboard configured to display input by one or more parties.

2. The system in accordance with claim 1 wherein said platform further comprises one or more algorithms implemented as machine readable code for processing by said processor in analyzing said facility data.

3. The system in accordance with claim 1 wherein said facility data comprises information regarding one or more aspects of the operation of a medical facility.

4. The system in accordance with claim 1 wherein said facility data comprises information regarding one more aspects of the operation of a manufacturing facility.

5. The system in accordance with claim 1 wherein said facility data comprises information regarding one or more aspects of the operation of a financial or investment institution.

6. The system in accordance with claim 1 wherein said step of transmitting facility data comprises transmitting said facility data in graphical form.

7. The system in accordance with claim 6 wherein said graphical form comprises one or more charts, bar, pie or other graphs.

8. The system in accordance with claim 1 wherein said one or more recommendations relate to actions for optimizing the operations of the facility.

9. The system in accordance with claim 8 wherein said actions relate to one or more of the group selected from: maximizing revenues, minimizing costs, maximizing customer satisfaction, maximizing customer service, minimizing defects or errors, and maximizing efficiency.

10. The system in accordance with claim 1 wherein said whiteboard comprises a portion of a graphical user interface configured to display input in real-time.

11. The system in accordance with claim 1 including at least one graphical user interface having four display areas, a first of said display areas configured to display said transmitted facility data, a second of said display areas configured to display said transmitted recommendations; a third of said display areas configured to display said transmitted video, and a fourth of said areas configured to display said whiteboard.

12. A method of providing closed-loop operations consulting comprising:
accepting at a remote provider platform facility data received from a facility regarding one or more operations of said facility;
storing said facility data;
analyzing said facility data to generate one or more recommendations regarding aspects of the operation of the facility;
establishing a communication link between said remote provider and said facility; and
conducting a live consultation via said communication link comprising:
transmitting facility data in analyzed or unanalyzed form for reference during the consultation;
transmitting one or more recommendations made in relation to the facility data relative to one or more aspects of the operation of the facility;
transmitting video and audio of a representative conducting the live consultation as captured at the at least one work station; and
transmitting a whiteboard configured to display input by one or more parties.

13. The method in accordance with claim 12 wherein said step of analyzing said facility data including the step of executing at least one algorithm implemented as machine readable code by said platform upon said facility data.

14. The method in accordance with claim 12 including said step of generating a graphical user interface having four display areas, a first of said display areas configured to display said transmitted facility data, a second of said display areas configured to display said transmitted recommendations; a third of said display areas configured to display said transmitted video, and a fourth of said areas configured to display said whiteboard.

15. The method in accordance with claim 12 wherein said facility data comprises information regarding one or more aspects of the operation of a medical facility.

16. The method in accordance with claim 12 wherein said facility data comprises information regarding one more aspects of the operation of a manufacturing facility.

17. The method in accordance with claim 12 wherein said facility data comprises information regarding one or more aspects of the operation of a financial or investment institution.

18. The method in accordance with claim 12 wherein said step of conducting said live consultation further comprises accepting video and audio of one or more personnel at said facility and displaying said video to said representative.

19. The method in accordance with claim 12 wherein said step of analyzing said facility data comprises providing said facility data to at least one expert for review.

20. The method in accordance with claim 12 wherein said facility and remote provider are located remotely from one another.
